(19) United States
(12) Patent Application Publication
(10) Pub. No.: US 2008/0300054 A1
(43) Pub. Date: Dec. 4, 2008

(54) METHOD AND APPARATUS FOR GENERATING SIMULATED GAME CONTROL SIGNALS

(75) Inventor: Anees Munshi, Woodbridge (CA)

Correspondence Address: BENNETT JONES LLP, 3400 ONE FIRST CANADIAN PLACE, PO BOX 130, TORONTO, ON, M5X 1A4, CA

(73) Assignee: ELECTRIC SPIN CORPORATION, Woodbridge (CA)

(21) Appl. No.: 12/128,172

(22) Filed: May 28, 2008

(30) Foreign Application Priority Data
May 28, 2007 (CA) 2590547

(51) Int. Cl. A63F 13/02

(52) U.S. Cl. 463/37

(57) ABSTRACT

An apparatus and a method for interfacing a gaming device with a gaming system having a proprietary or secure protocol for inputting gaming signals. The gaming system is communicatively coupled to an input device for receiving gaming signals encoded according to the proprietary or secure protocol. The apparatus comprises a module for converting signals from the gaming device into a first format and a module for transmitting the first format signals to the input device. The input device includes a component for converting the first format signals into signals according to the proprietary protocol and transmitting the converted signals to the gaming system. According to one embodiment, the first format signals comprise simulated input control signals for the input device.

### FIELD OF THE INVENTION

The present invention relates to computer-based gaming systems, and more particularly to a method and apparatus for generating simulated game control signals for gaming consoles.

### BACKGROUND OF THE INVENTION

Computer-based gaming devices typically comprise a console and an input device. The console may include a display or at least a port for outputting a video signal to a video display terminal. The input device, for example, a handheld gamepad or game controller, is coupled to the console through a port, which may comprise a hardwire connection or a wireless connection. While the connection between the input device, i.e. game controller or gamepad, may utilize a conventional communication standard or protocol, e.g. USB or RS-232, the control signals may also be encrypted, encoded or otherwise secured, making it difficult for a third party game controller or other device to be plugged directly into the console. In other instances, the connection between the game controller and the console may be based on a proprietary communication standard or closed architecture making it virtually impossible to “port” a game controller or gamepad to the console.

It will be appreciated that there are advantages in allowing third party devices to interface with known and yet-to-be developed gaming devices and consoles. Accordingly, there remains a need for improvements in the art.

### BRIEF SUMMARY OF THE INVENTION

The present invention comprises a method and apparatus for generating simulated game control signals for a gaining system, such as a game console having a proprietary protocol or closed interface architecture.

According to an embodiment, the present invention comprises an apparatus for a gaming system, the apparatus comprises: an input for coupling to a gaming device for receiving a gaming signal; a module for converting the received gaming signal into a first format, the first format signal being compatible with an input device for the gaming system; the input device including a component for converting the first format signal into a second format, wherein the second format is compatible with a game console; and the input device includes a component for transmitting the second format signal to the game console.

According to another embodiment, the present invention comprises a method for interfacing a gaming device with a game console, the game console being operatively coupled to an input device for receiving encoded output signals from the input device, the method comprises: converting one or more output signals generated by the gaming device into one or more simulated input signals; applying the simulated input signals to the input device; converting the simulated input signals at the input device into encoded output signals; and transmitting the encoded output signals from the input device to the game console.

According to yet another embodiment, the present invention comprises an apparatus for coupling a gaming device to a gaming system configured for receiving encoded signals from an input device, the apparatus comprises: an input port for receiving one or more output signals from the gaming device; a component for converting the received signals into one or more simulated signals; an output port for outputting the simulated signals to an input device; the input device being communicatively coupled to the gaming system and including a component for converting the simulated signals into corresponding encoded signals and a component for transmitting the encoded signals to the gaming system.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary gaming system suitable for utilizing embodiments of the present invention;

FIG. 2 shows in block diagram form an embodiment of a gamepad interface module for a gamepad according to an embodiment of the invention;

FIG. 3 shows in block diagram form an embodiment of a gamepad interface module for a gamepad according to an embodiment of the invention;

FIG. 4 shows in schematic form exemplary simulated signals generated for an input device or gamepad; and

FIG. 5 shows in flowchart form a process for generating simulated game control signals according to an embodiment of the present invention.

In the drawings, like reference numerals indicate like elements.

### DETAILED DESCRIPTION OF THE EMBODIMENTS

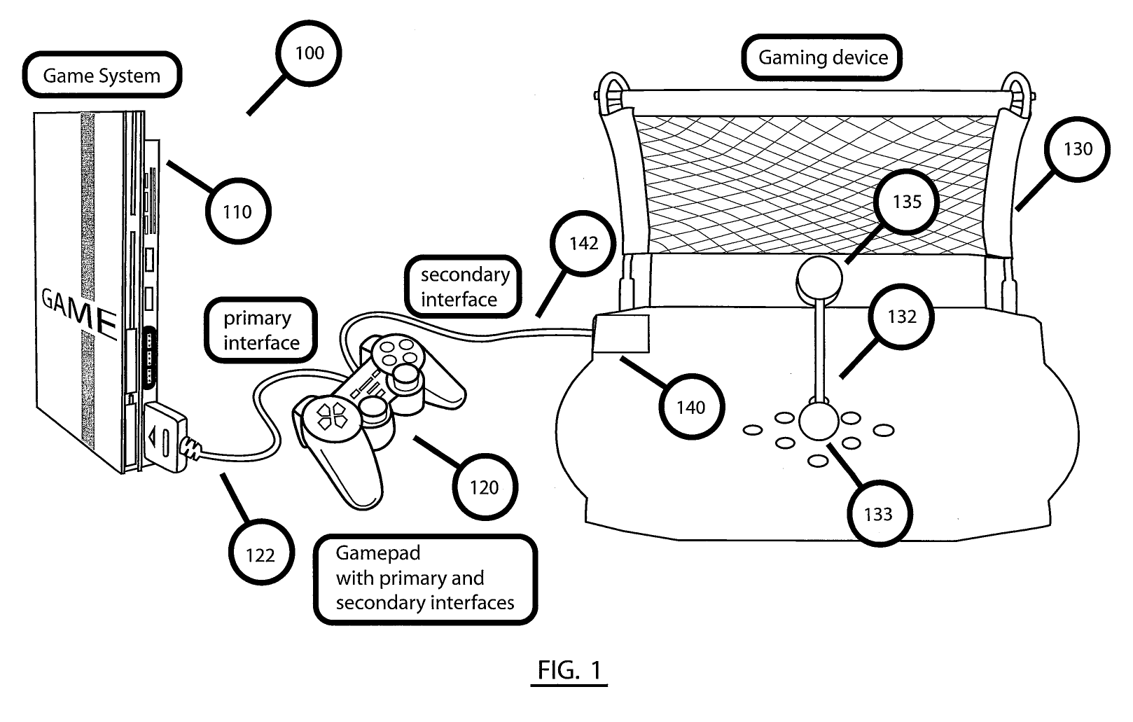

Reference is first made to FIG. 1, which shows an exemplary gaming system suitable for practicing an embodiment of the present invention. The gaming system is indicated generally by reference 100 and includes, as shown, a game console 110 and an input device 120, e.g. a gamepad or game controller. As shown, a gaming device indicated generally by reference 130 is coupled to the gamepad 120 through an interface according to an embodiment of the invention as will be described in more detail below. The gaming device 130 may comprise the Golf Launchpad™ golf simulator from Electric˜Spin Corporation in Woodbridge, Ontario, Canada. It will however be appreciated that other gaming devices or simulators may be used or interfaced to the game console 110 according to other embodiments of the invention. In the context of the present description, the gaming system 100 comprises the Xbox 360™ from Microsoft Corporation, together with the gamepad or game controller 120.

The Golf Launchpad™ golf simulator comprises a gaming device 130 that allows a player to play/practice the game of golf under realistic simulated conditions. As shown in FIG. 1, the Launchpad™ golf simulator includes a simulation projectile 132 comprising a golf ball and integrated sensors 133. The player strikes the golf ball 133 with a golf club and the sensor readings are translated into signals for the game console 110, which runs a program for simulating a golf game.

As shown in FIG. 1, the gamepad 120 includes a primary interface 122 (e.g. a cable and port) and a secondary interface 142 according to an embodiment of the invention. The primary interface 122 couples the input device (i.e. the gamepad) 120 to the game console 110, and may comprise a proprietary, secured, encrypted or closed architecture protocol. The secondary interface 142 couples the gaming device 130 to the game console 110 and as will be described in more detail below comprises an interface module 140 that provides the capability for the gaming device 130 to “talk” to the game console 110 notwithstanding that the primary interface 122 comprises a proprietary, encrypted, encoded or other type of secured interface. The interface module 140 may be integrated with the gaming device 130. According to another embodiment, the interface module 140 may comprise an external component which plugs into an output port on the gaming device 130 and includes a port for coupling to the secondary interface cable 142.

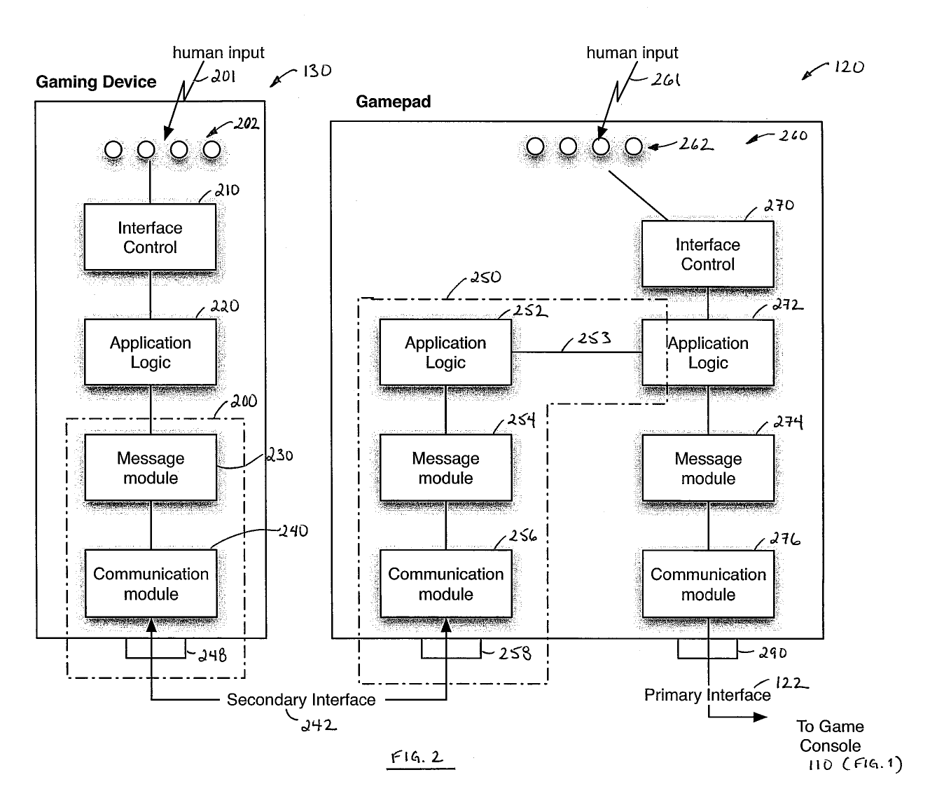

Reference is made to FIG. 2, which shows an embodiment of a gaming device 130 and an input device (i.e. gamepad) 120. As will be described, the gaming device 130 and the gamepad 120 include an interface for interfacing the gaming device 130 to the game console 110 via the gamepad 120. According to one aspect, the interface module 200 provides the capability for generating simulated input signals, e.g. simulated human input signals, from the gaming device 130 for input to the gamepad 120 and having a form suitable for the gamepad 120 to “play through” to the game console 110. According to this aspect, the interface module 200 provides the capability to operate a gaming device 130, such as the Golf Launchpad™ golf simulator, with a gaming console 110 having a proprietary or secured interface or port for the gamepad 120 or other external devices.

As shown in FIG. 2, the gaming device 130 includes a game input control module 202, an interface control module 210, an application logic module 220 and an interface module indicated generally by reference 200. As shown, the interface module 200 comprises a message module 230, a communication module 240, and a communication port 248. The game input control module 202 may comprise one or more sensors and inputs, for example, from the sensors associated with the Golf Launchpad™ golf simulator. According to another embodiment, the game input control module 202 comprises one or more buttons, joystick controllers and/or LED's, and associated electronic circuits, which are responsive to a human/player input indicated generally by reference 201. The interface control module 210 functions to receive the output signals generated by the electronic circuit(s) associated with the game input control module 202 and transfer the signals to the application logic module 220 for further processing. The interface module 200 is shown as a component of the gaming device 130, for example, as indicated by reference 140 in FIG. 1. It will be appreciated that the interface module 200 may comprise a separate component, for example, an external component or “box” which coupled to the gaming device 130 via a cable or other communication link. In accordance with an aspect of the present invention, the gamepad 120 includes a secondary interface module indicated by reference 250. The secondary interface module 250 includes an application logic module 252, a message module 254, a communication module 256 and a communication port 258. The interface module 200 is coupled to the secondary interface module 250 in the gamepad 120 via a secondary interface cable 242 (indicated by reference 142 in FIG. 1) which is connected to the communication ports 248 and 258.

As shown in FIG. 2, the gamepad 120 also includes a gamepad module 260 comprising a game input control module 262, an interface control module 270, an application logic module 272, a message module 274, a communication module 276, and a communication port 290 for the primary interface 122 (FIG. 1). The game input control module 262 comprises one or more buttons, joystick controllers and/or LED's, and associated electronic circuit(s) or logic elements. The game input control module 262 is responsive to a human/player input indicated generally by reference 261 and the associated electronic circuit elements generate output signals, for example, in response to button presses and/or joystick movement or actuation, which are received by the interface control module 270 and processed by the gamepad module 260 and transmitted to the game console 110 (FIG. 1) via the communication port 290 and the primary interface 122. The gamepad module 260 for the gamepad 120 is implemented in known manner. According to this embodiment of the invention, the input signals generated by the interface control module 210, for example, in response to a human playing the gaming device 130, are transmitted or transferred directly to the application logic module 272 of the gamepad module 262, for example, as described in more detail below.

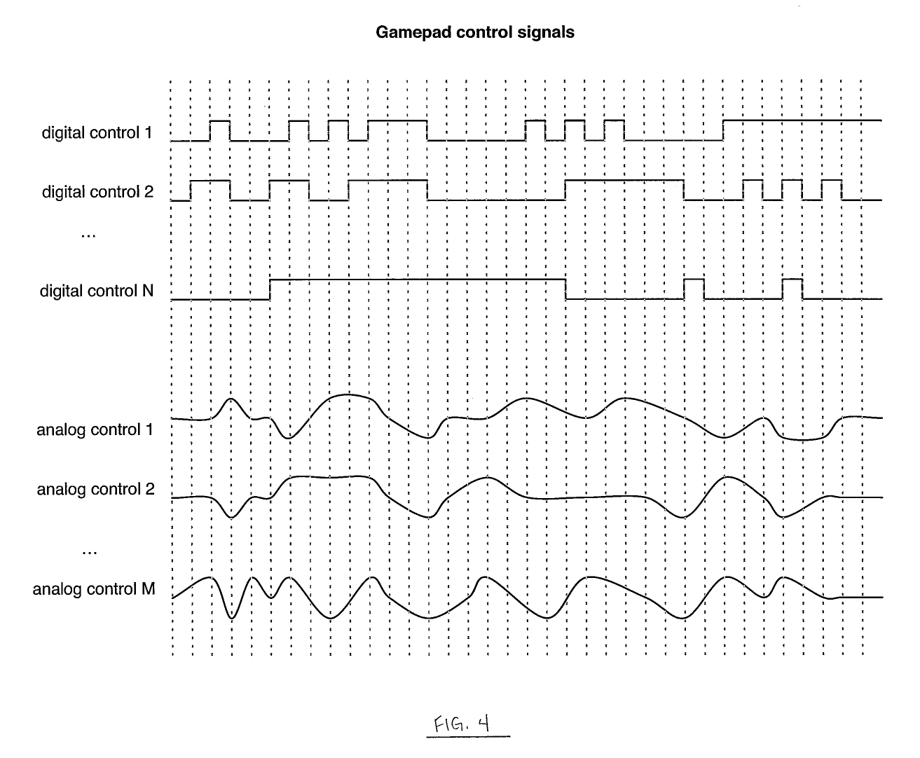

In response to human input 201 (e.g. a player striking the golf ball 133—FIG. 1), the game input control module 202 generates one or more output signals for the interface control module 210. The interface module 210 provides the interface for analog and digital devices, e.g. sensors, buttons, joysticks, etc., in the game input control module 202. FIG. 4 depicts exemplary signals generated by digital controls 1 to N and analog controls 1 to M on the game input control module 202. The interface control module 210 is coupled to the application logic module 220, which converts the signals into a suitable message or command format and also oversees the operation of the gaming device 130 and the interface module 200. The message module 230 functions to create and parse the signals into simulated signal control messages that are transmitted to the secondary interface module 250 on the gamepad device. The communication modules 240 and 256 oversee the transmission and reception of the messages on the physical interface, i.e. the secondary interface 242. The message module 254 in the secondary interface module 250 receives and parses the messages and passes them to the application logic module 252 which converts them into a form that simulates signals responses generated in response to human inputs applied to the game input control module 262 of the gamepad 120. According to one embodiment, the application logic module 252 is coupled to a port on the application logic module 272 via a communication link or channel indicated by reference 253. According to another embodiment, the application logic 252 functions to generate simulated input signals in the game input control module 262, for example, at the electronic circuit level, which are processed by the interface control module 270 as if they originated from the input control module 262. The application logic module 272 treats the simulated input signals as conventional signals from the game input control module 262. The signals are processed and transmitted to the game console 110 (FIG. 1) via the primary interface 122.

The communication modules 240 and 256 are implemented in known manner based on the protocol being utilized, for example, a bi-directional serial NRZ asynchronous link, as described in more detail below. The message modules 230 and 254 comprise compatible encoder/decoder devices, e.g. CODEC's, and provide the mechanism for encoding and decoding messages/commands transmitted between the interface module 200 in the gaming device 130 and the secondary interface module 250 in the gamepad 120. According to one embodiment, the interface module 200 may be integrated or housed with the gaming device 130, for example, as indicated by reference 140 in FIG. 1.

The interface module 200 and the secondary interface module 250 may be implemented as one or more software modules or objects executed by a microprocessor operating under stored program control, or as a combination of software and hardware components, or as a hardware logic device (for example, a Field Programmable Gate Array or FPGA), to provide the functionality as described herein. The particular implementation details will be within the understanding of one skilled in the art.

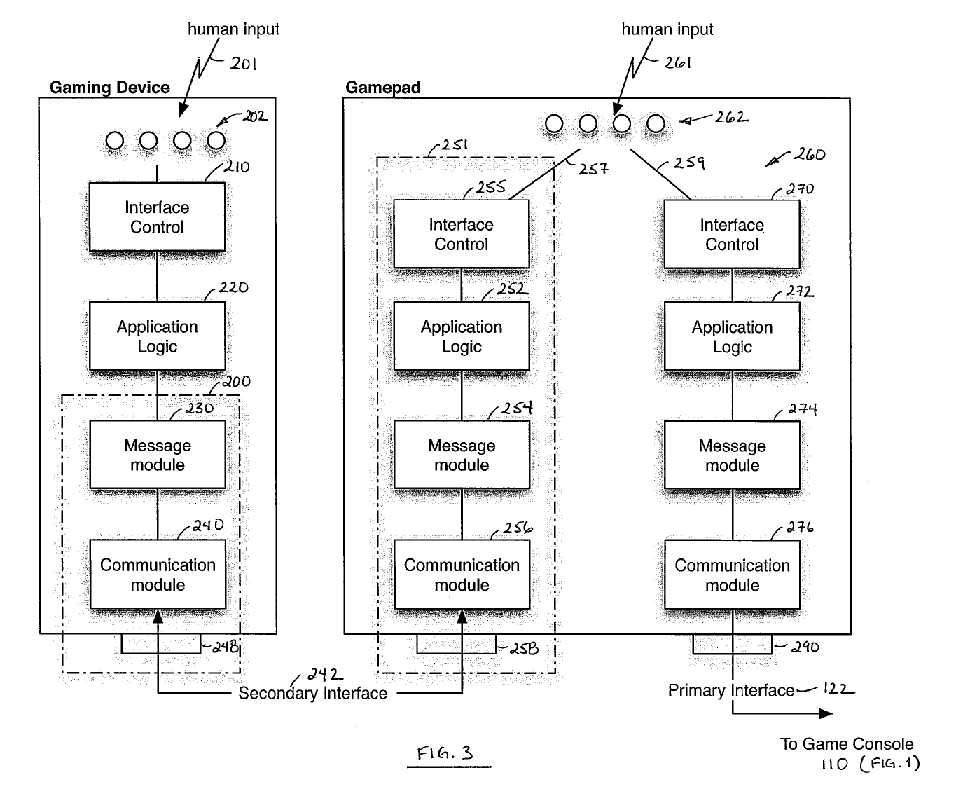

Reference is next made to FIG. 3, which shows a secondary interface module according to another embodiment of the present invention and indicated generally by reference 251. As shown, the secondary interface module 251 includes an interface control module 255. The interface control module 255 is coupled to the application logic module 252 and receives the messages for the simulated inputs from the interface module 200 as described above. The remaining components are indicated by like references and function in similar manner as described above. In accordance with this embodiment, the interface control module 255 converts the simulated signals into corresponding digital and/or analog signals which are applied to the game input control 262 (e.g. the electronic circuits associated with the respective inputs, for example, the buttons, joystick, etc.) of the gamepad 130 via a link indicated by reference 257. The game input control module 262 sees the applied signals as human inputs and outputs corresponding or associated signals to the interface control module 270 via a link or channel 259. The outputs from the game input control module 262 are processed by the gamepad module 260, i.e. by the interface control module 272 and the application logic module 274, and transmitted to the game console 110 (FIG. 1), i.e. by the message module 274 and the communication module 276, as described above.

The following is an exemplary communication protocol or control/message structure for an implementation of the Golf Launchpad™ golf simulator and the XBox™ gaming system from Microsoft Corporation interfaced with a gamepad device. According to one embodiment, the secondary interface 142 (FIG. 1) comprises a bi-directional serial NRZ asynchronous link running at 9600 bps, no parity, 8 data bits and one stop bit. The secondary interface 142 is coupled to a port on the controller of the gamepad device. In addition to power and ground, two signal wires are utilized as follows: (1) Data In is used to send data to the XBox™ gamepad, and (2) Data Out is used to by the XBox™ gamepad to send data to the Launchpad™ golf simulator. The communication protocol according to this embodiment provides the following functions: (1) communication of “shot data” from the Golf Launchpad™ golf simulator to the gamepad; and (2) communication of real-time change of state from the Launchpad™ to the gamepad.

According to another aspect of the invention, the communication format and the message protocol is implemented to provide real-time transmissions of the simulated signals to the game console preferably without perceptible delays or slow down to the user. According to one embodiment, the communication is implemented in the form of real-time streaming wherein the control signals are transmitted to the input device (e.g. gamepad) to be converted and relayed to the game console. According to another embodiment, the communication format may comprise a message format and protocol as described below.

According to one embodiment, the communication protocol comprises a master/slave protocol with the Golf Launchpad™ gaming device 130 comprising the master device and the gamepad 120 comprising the slave device. Each command/message from the Golf Launchpad™ gaming device 130 is acknowledged by the gamepad 120 to provide a positive handshake.

According to an embodiment, the commands originating from the Golf Launchpad™ gaming device comprise:
State Report: this message is generated in the event of a state change caused by a user event or in order to query the button status of gamepad. The gamepad uses the state data to set the colour of its LED. State Report messages are re-sent periodically (except in ACTIVE state) even if no change of state occurs to (1) poll gamepad's button and to (2) serve as a keep alive.
Play Shot: this message is generated when the user takes a shot on the Golf Launchpad™ device. The gamepad uses this data to generate a shot on the XBox 360 interface.
Test Report: this message is generated after a self-test is complete, and provides Automated Test Equipment or ATE equipment with a test report.
ATTN: this message is used to trigger an exception in the gamepad; may be used for testing purposes only (to be defined if required).

According to an embodiment, the messages originating from a gamepad comprise the following:
ACK/NACK: this message is used to respond to the gaming device
ATTN: this message is used by the gamepad to trigger an exception in gaming device, and may be used, for example, for testing purposes.

According to an embodiment, each message is followed by an ACK/NACK. Once a communication has been initiated by the gaming device (i.e. a Golf Launchpad™ golf simulator), the communication is either acknowledged, i.e. ACK'ed, by the gamepad, or NACK'ed by the gamepad. In response to a NACK, the Golf Launchpad™ golf simulator retransmits the command until it is ACK'ed by the gamepad. If neither ACK nor NACK is received within a predetermined time, for example, 20 ms after the end of transmission of the command, then the Golf Launchpad™ treats the silence as a NACK and re-transmits the command.

According to another aspect, the gaming device (i.e. a Golf Launchpad™ golf simulator) enters a COMM FAIL state if multiple consecutive commands (or retransmissions) result in either NACK or no response. In the COMM FAIL state, the gaming device attempts to communicate with the gamepad periodically, and will exit the COMM FAIL state when communication is re-established. The gamepad may also enter a COMM FAIL state if it receives multiple malformed messages, for example, five (5) malformed messages from the gaming device, or if a predetermined period of time elapses with no communication, for example, 500 ms of silence (no communication) between transmissions (except if the Golf Launchpad™ is in the ACTIVE state, when it may not send transmissions or may send infrequent transmissions). The gamepad will exit COMM FAIL state after receiving a correct transmission from the Golf Launchpad™. During the gamepad's COMM FAIL state, it must continue responding ACK/NACK to the messages from the Golf Launchpad™ simulator.

An exemplary transaction may take the following form:
The Golf Launchpad™ golf simulator sends a 0×56 (State) command; if the command is garbled, the gamepad sends the message NACK 0×58. The Golf Launchpad™ retransmits the Query command, and the gamepad responds with the message, ACK 0×58, indicating that activate button is pressed.
If the Golf Launchpad™ golf simulator is in IDLE state, then it sets it state to Active and sends a 0×56 state report message to the gamepad, and the gamepad responds with a 0×58 ACK message and turns its status LED green.

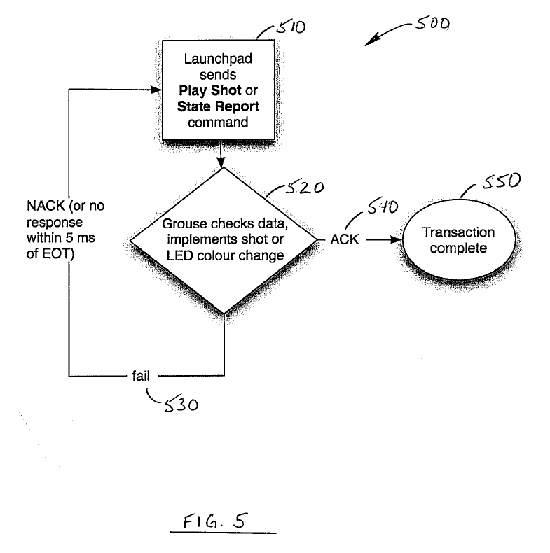

An exemplary transaction is further illustrated with reference to the flowchart depicted in FIG. 5. The process is indicated generally by reference 500 and comprises steps/operations 510, 520, 530, 540 and 550.

In the context of the Golf LaunchPad™ gaming device, the “Play Shot” message described above may be implemented and handled as follows:
the Golf Launchpad™ sends a “Play Shot” (e.g. 0×55) command to the gamepad whenever a shot is taken on the Golf Launchpad™, or when a simulated shot is taken in USER TEST and EMI modes. The gamepad plays the “shot” through to the XBox 360™.
after transmitting an ACK message to the Golf Launchpad™, the gamepad listens for 10 ms for any retransmissions from the Golf Launchpad™ before playing the shot through to the XBox 360™. This serves to ensure that if the Golf Launchpad™ retransmits the Play Shot command, the gamepad does not go into COMM FAIL mode.
after receiving an ACK message from the gamepad to the Play Shot command, the Golf Launchpad™ gives the gamepad 2 seconds to play the shot (i.e. transmit the play shot signal to the Xbox game console) before sending any other commands.
   The Playshot message comprises a multiple field command and includes a field for specifying a backswing motion Y, a field for specifying a backswing motion X, a field for specifying a backswing pause, a field for specifying a downswing motion Y, a field for specifying a downswing motion X, a field for specifying a hold period (defined by the time base), a field for specifying a shot counter, a field for specifying a backswing motion X, a field for specifying a time base, and a field for specifying a checksum.

In the context of the Golf Launchpad™ gaming device and a gamepad device, the “ACK/NACK Shot” message described above may be implemented and handled as follows:
when the Gamepad receives a message successfully from the Golf Launchpad™, the gamepad issues an ACK message within a predetermined period, for example, 20 ms, of receiving the last byte of the message. If the message is corrupted, for example, as indicated by an incorrect checksum, the transmission may be NACK'ed.
if the Golf Launchpad™ receives neither an ACK or NACK message, it assumes that the message was NACK'ed. An ACK message includes the status of the gamepad's button.
a short button press is treated by Golf Launchpad™ as a drive mode activation, i.e. the Golf Launchpad™ disambiguates for right- and left-handed shots.
a long button press is treated by the Golf Launchpad™ as a putt mode activation.

In accordance with another embodiment, when the simulated inputs or manipulations of the gaming device are simple and/or limited, for example, comprising a limited number or types of motions, the communication protocol is implemented in the form of a vocabulary of commands or messages that describe specific motions rather than transmitting the actual values of the control signals, for example, as described above.

While embodiments of the present invention are described in the context of game controllers and game consoles, it is to be appreciated that the apparatus and methods according to the present invention provide the capability to interface other types of electronic and computing devices to a game console.

The present invention may be embodied in other specific forms without departing from the spirit or essential characteristics thereof. Certain adaptations and modifications will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. An apparatus for a gaming system, said apparatus comprising:
an input for coupling to a gaming device for receiving a gaming signal;
a module for converting said received gaming signal into a first format, said first format signal being compatible with an input device for the gaming system;
a module for transmitting said first format signal to said input device;
said input device including a component for converting said first format signal into a second format, wherein said second format is compatible with a game console; and
said input device including a component for transmitting said second format signal to said game console.

2. The apparatus as claimed in claim 1, wherein said first format signal comprises a signal simulating a human input signal for the input device.

3. The apparatus as claimed in claim 2, wherein said second format signal comprise a signal encoded with a proprietary protocol.

4. The apparatus as claimed in claim 3, wherein said input device comprises a gamepad and said gaming device comprises a strike projectile game.

5. A method for interfacing a gaming device with a game console, said game console being operatively coupled to an input device for receiving encoded output signals from said input device, said method comprising:
converting one or more output signals generated by said gaming device into one or more simulated input signals;
applying said simulated input signals to said input device;
converting said simulated input signals at said input device into encoded output signals; and
transmitting said encoded output signals from said input device to said game console.

6. The method as claimed in claim 5, wherein said input device comprises a gamepad device having a first communication port coupled to said game console for transmitting said encoded output signals, and a second communication port coupled to said gaming device and being capable of receiving said one or more simulated input signals.

7. An apparatus for coupling a gaming device to a gaming system configured for receiving encoded signals from an input device, said apparatus comprising:
an input port for receiving one or more output signals from said gaming device;
a component for converting said received signals into one or more simulated signals;
an output port for outputting said simulated signals to an input device;
said input device being communicatively coupled to said gaming system and including a component for converting said simulated signals into corresponding encoded signals and a component for transmitting said encoded signals to said gaming system.

8. The apparatus as claimed in claim 7, wherein said simulated signals comprise simulated input signals having a format compatible with said input device.

9. The apparatus as claimed in claim 8, wherein said input device comprises a gamepad device.

10. The apparatus as claimed in claim 9, wherein said simulated input signals are transmitted to said input device in the form of one or more commands.

11. The apparatus as claimed in claim 10, wherein said input device includes a component for generating a reply message and said reply message being generated in response to reception of a transmit message.
